(19) United States
(12) Patent Application Publication
(10) Pub. No.: US 2005/0127028 A1
(43) Pub. Date: Jun. 16, 2005

(54) Method for fabricating an enlarged fluid channel

(76) Inventors: Wei-Lin Chen, Taipei (TW); Hung-Sheng Hu, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/987,087

(22) Filed: Nov. 12, 2004

(30) Foreign Application Priority Data
Nov. 13, 2003 (TW) 92131771

(51) Int. Cl. G01D 15/00

(52) U.S. Cl. 216/27

(57) ABSTRACT

A method for fabricating an enlarged fluid channel. The method includes providing a substrate with a patterned sacrificial layer thereon. A patterned support layer is formed on the substrate and covers the sacrificial layer. A fluid channel is formed by wet etching the substrate and exposing the sacrificial layer. A first chamber is formed by removing a portion of the sacrificial layer in the wet etching process. Finally, the first chamber and the exit-end of the fluid channel are enlarged by wet etching. More specifically, the exit-end of the fluid channel is enlarged using multiple steps of etching the sacrificial layer without changing the dimensions of the entry-end of the fluid channel.

### BACKGROUND OF THE INVENTION

1. Field of the Invention

The invention relates to a method for manufacturing a fluid injector; in particular, a method for manufacturing a fluid injector using multiple steps of removing and etching a sacrificial layer to enlarge the fluid channel.

2. Description of the Related Art

Typically, fluid injectors are applied in an ink-jet printer, a fuel injector, and other devices. Among ink-jet printers presently known and used, injection by thermally driven bubbles has been most successful due to its simplicity and relatively low cost.

FIG. 1 is a conventional monolithic fluid injector 1 as disclosed in U.S. Pat. No. 6,102,530. A structural layer 12 is formed on a silicon substrate 10. A fluid chamber 14 is formed between the silicon substrate 10 and the structural layer 12 to receive fluid 26. A first heater 20 and a second heater 22 are disposed on the structural layer 12. The first heater 20 generates a first bubble 30 in the chamber 14, and the second heater 22 generates a second bubble 32 in the chamber 14 to eject the fluid 26 from the chamber 14.

The conventional method for fabricating a monolithic fluid injector 1 comprises providing a silicon substrate 10. A patterned sacrificial layer is formed on the first surface of the substrate 10. A patterned structural layer 12 is formed on the surface of the substrate 10 and covers the patterned sacrificial layer. A fluid actuator is formed on the structural layer. A passivation layer is formed on the structural layer covering the fluid actuator. A fluid channel is formed in the second surface of the substrate, opposing the first surface, and exposing the sacrificial layer. The sacrificial layer is removed to form a fluid chamber, and the fluid chamber is enlarged by anisotropic etching of the silicon substrate. Subsequently, a through hole is formed by sequentially etching the passivation layer and the structural layer, wherein the through hole is communicated with the fluid channel.

Additionally, the conventional monolithic fluid injector 1 typically employs a <100> oriented single crystal silicon wafer to serve as a substrate. During anisotropic etching, a pyramid structure is formed along the (111) sidewall at a 54.7° angle with the substrate surface. The aforementioned process is provided to form a fluid channel of a monolithic fluid injector. Due to the nature of silicon anisotropic etching, however, both the entry-end and exit-end of the fluid channel are enlarged when the fluid chamber is enlarged. Hence, if the entry-end of the fluid channel is enlarged, the nozzle density may be reduced and the strength of the fluid injector may be weakened.

### SUMMARY OF THE INVENTION

An object of the present invention is to provide multiple steps of removing and anisotropically etching the sacrificial layer to enlarge the exit-end of the fluid channel instead of enlarging the entry-end of the fluid channel.

Accordingly, the invention provides a method for fabricating an enlarged fluid channel. The method comprises providing a substrate having a first surface and a second surface, forming a patterned sacrificial layer on the first surface of the substrate, forming a patterned structural layer on the first surface of the substrate covering the patterned sacrificial layer, forming a fluid channel in the second surface of the substrate, opposite to the first surface, and exposing the sacrificial layer, removing a portion of the sacrificial layer to form a first chamber, and removing the remaining portion of the sacrificial layer to form a second chamber.

A fluid actuator, a driving circuit communicating with the fluid actuator and a passivation layer covering the fluid actuator and the driving circuit are formed on the structural layer.

It is understood that the sacrificial layer comprises borophosphosilicate glass (BPSG), phosphosilicate glass (PSG), or silicon oxide. The structural layer comprises a silicon oxynitride.

The exit-end of the fluid channel is anisotropically etched using KOH, tetramethyl ammonium hydroxide (EDP), or ethylene diamine pyrochatechol (EDP) soluition.

The method for fabricating an enlarged fluid channel further comprises multiple steps of removing and etching a portion of the sacrificial layer and enlarging the fluid chamber.

A nozzle is formed by etching the structural layer, thereby communicating the enlarged fluid chamber. The fluid is ejected from the nozzle.

The present invention improves on the related art in that repeating the steps of removing and anisotropically etching the sacrificial layer to enlarge the exit-end of the fluid channel instead of enlarging the entry-end of the fluid channel. Furthermore, the die density can increase and the strength of the fluid injector can be maintained.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic view of a conventional monolithic fluid injector; and

FIGS. 2-7 are schematic views of a method for manufacturing an enlarged fluid chamber according to the present invention.

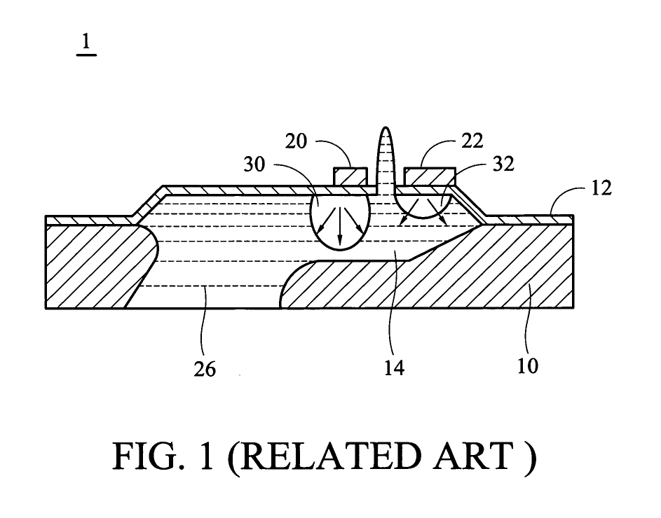

### DETAILED DESCRIPTION OF THE INVENTION

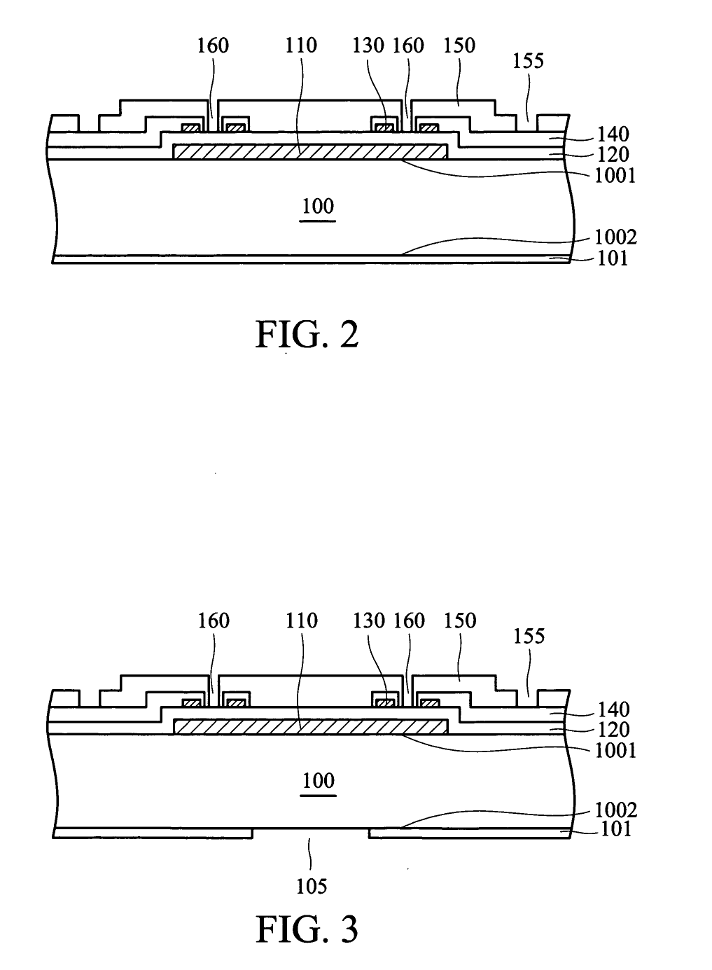

FIGS. 2-7 are schematic views of a method for manufacturing a fluid injector using multiple steps of removing and anisotropic etching of the sacrificial layer to enlarge the exit-end of the fluid channel instead of enlarging the entry-end of the fluid channel. Referring to FIG. 2, a substrate 100, such as a single crystal silicon wafer, having a first surface 1001 and a second surface 1002 is provided. A patterned sacrificial layer 110 is formed on the first surface 1101 of the silicon substrate 100. The sacrificial layer comprises borophosphosilicate glass (BPSG), phosphosilicate glass (PSG), or other silicon oxide material. Sequentially, a patterned structural layer 120 is conformally formed on the first surface 1001 of the substrate 100 covering the patterned sacrificial layer 110. The structural layer 120 is a low stress silicon oxynitride (SiON) or silicon nitride (SiN). The stress of the silicon oxynitride (SiON) is about 100 to 200 MPa. The low stress silicon oxynitride (SiON) is deposited by chemical vapor deposition (CVD). A low stress silicon oxynitride (SiON) 101 is simultaneously formed on the second surface 1002 of the silicon substrate 100.

A fluid actuator 130, a signal transmitting circuit 140 communicating with the fluid actuator 130 and a passivation layer 150 covering the fluid actuator 130 and the signal transmitting circuit 140 are formed on the structural layer 120. The fluid actuator 130 comprises a thermal bubble actuator or a piezoelectric actuator. The thermal bubble actuator comprises a patterned resist layer. The patterned resist layer is formed on the structural layer 120 to serve as a heater. The resist layer comprises HfB₂, TaAl, TaN, or TiN. The resist layer can be deposited using PVD, such as evaporation, sputtering, or reactive sputtering.

Sequentially, a patterned conductive layer 140, such as Al, Cu, or Al—Cu alloy, is formed on the structural layer 120 communicating with the resist layer 130 to act as a signal transmitting circuit 140. The conductive layer 140 may be deposited using PVD, such as evaporation, sputtering, or reactive sputtering. A passivation layer 150 is formed on the substrate 100 covering the structural layer 120 and the signal transmitting circuit 140. The passivation layer comprises an opening 155 exposing the contact pad of the signal transmitting circuit.

Referring to FIG. 3, an opening 105 is defined in the low stress silicon oxynitride (SiON) layer 101 exposing the second face 1002 of the single crystal silicon substrate 100. While forming the fluid channel, the opening 105 serves as a hard mask during etching of the single crystal silicon substrate 100. The dimensions of the opening 105 are equal to the entry-end of the fluid channel.

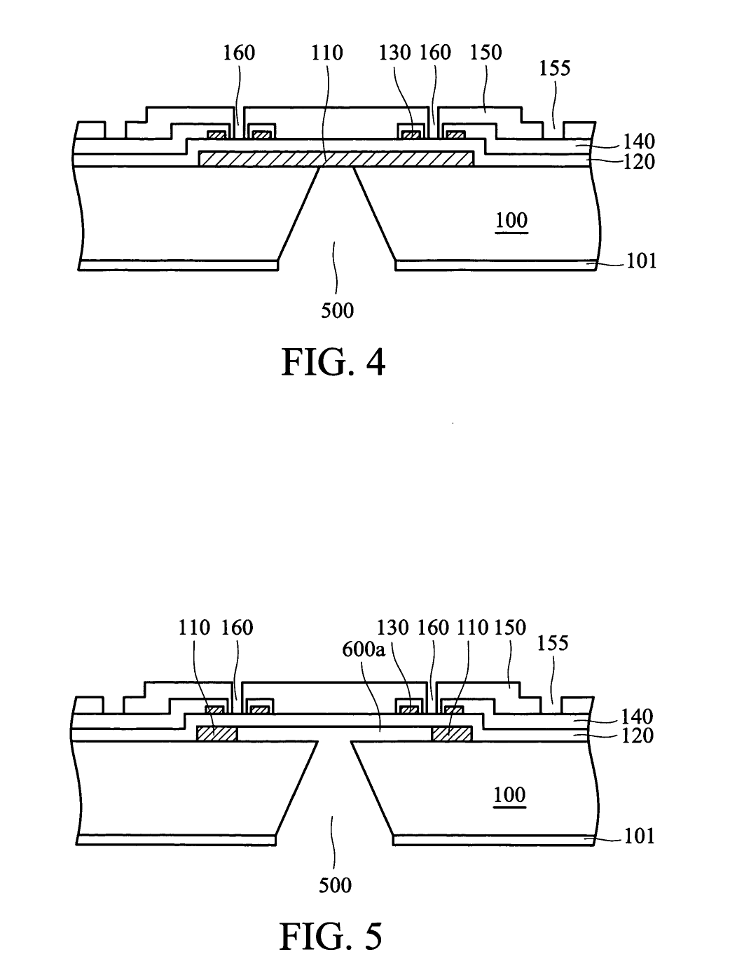

Referring to FIG. 4, The second silicon substrate surface is etched by wet etching to form a fluid channel 500. The fluid channel 500 exposes the sacrificial layer 110. Preferably, wet etching is performed using KOH, tetramethyl ammonium hydroxide (EDP), or ethylene diamine pyrochatechol (EDP) solution.

Referring to FIG. 5, a portion of the sacrificial layer 110 is etched and removed by wet etching or dry etching to form a first fluid chamber 600a. Wet etching is performed using HF or buffer oxide etching (BOE) solution. The amount of wet etching is determined by real-time control. The entry-end of the fluid channel is dependent on the removed portion of the exit-end of the fluid channel.

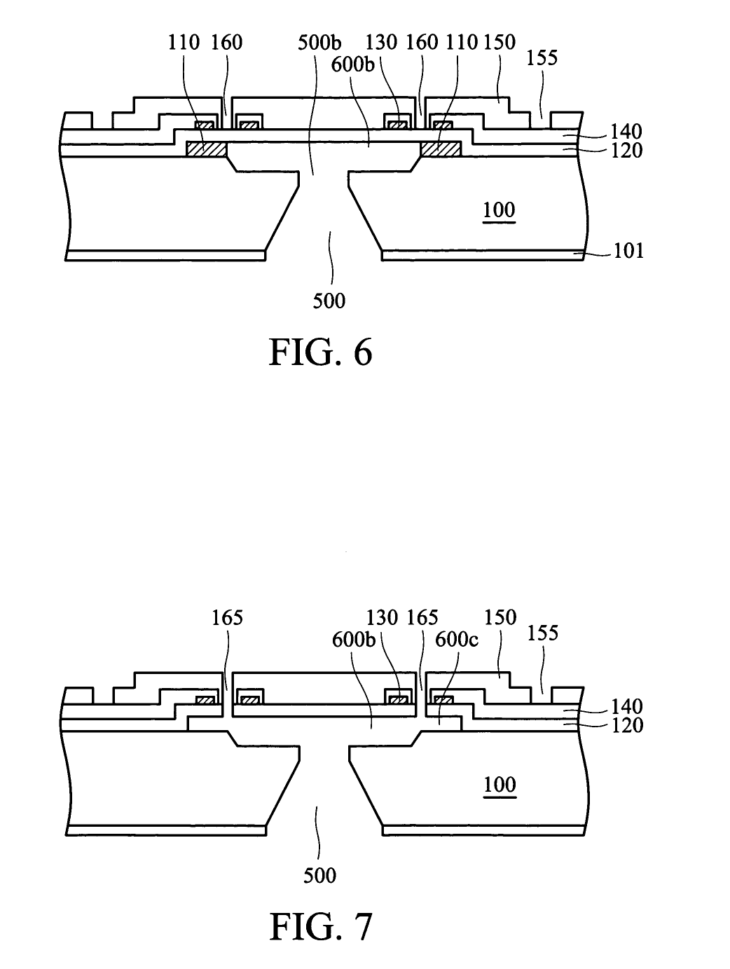

Referring to FIG. 6, The exposed surface of the single crystal silicon substrate is etched and the first chamber 600a is enlarged by wet etching. An enlarged first chamber 600b is thus formed. The exit-end of the fluid channel 500 is also enlarged to desired dimensions simultaneously. Etching of the exposed surface of the silicon substrate and the first chamber 600a is dependent on real-time control. If the etching is complete, the edge of the fluid chamber will be rounded and create an over enlarged fluid channel. The over enlarged fluid channel leads to cross-talk between adjacent fluid chambers during fluid ejection. Preferably, wet etching is performed using KOH, tetramethyl ammonium hydroxide (EDP), or ethylene diamine pyrochatechol (EDP) solution.

In another embodiment of the present invention, removing a portion of the sacrificial layer and enlarging the fluid chamber and exit-end of the fluid channel can be repeated twice or more times, depending on the dimensions of the exit-end 500b of the fluid channel.

Referring to FIG. 7, the remaining portion of the sacrificial layer is removed by wet etching or dry etching to form a second fluid chamber 600c. Etching the remaining portion of the sacrificial layer is performed using HF or buffer oxide etching (BOE) solution. Subsequently, the second fluid chamber 600c is enlarged by wet etching. The exit-end of the fluid channel 500 is simultaneously enlarged to desired dimensions. Preferably, wet etching is performed using KOH, tetramethyl ammonium hydroxide (EDP), or ethylene diamine pyrochatechol (EDP) solution.

A nozzle 165 is formed by etching the structural layer 120 along the opening 160. The nozzle 160 communicates with the fluid channel for ejecting micro fluid from the nozzle 160. The nozzle 160 is preferably formed by plasma etching, chemical dry etching, reactive ion etching (RIE), or laser ablation. A monolithic fluid injector is thus obtained by multiple steps of anisotropic etching and removal of the sacrificial layer with an enlarged exit-end.

While the invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

1. A method for fabricating an enlarged fluid channel comprising:
providing a substrate having a first surface and a second surface;
forming a patterned sacrificial layer on the first surface of the substrate;
forming a patterned structural layer on the first surface of the substrate covering the patterned sacrificial layer;
forming a fluid channel in the second surface of the substrate, opposite to the first surface, and exposing the sacrificial layer;
removing a portion of the sacrificial layer to form a first chamber; and
removing the remaining portion of the sacrificial layer to form a second chamber.

2. The method as claimed in claim 1, further comprising:
forming a fluid actuator, a driving circuit communicating with the fluid actuator and a passivation layer covering the fluid actuator and the driving circuit on the structural layer.

3. The method as claimed in claim 1, wherein the sacrificial layer comprises borophosphosilicate glass (BPSG), phosphosilicate glass (PSG), or silicon oxide.

4. The method as claimed in claim 1, wherein the structural layer comprises a silicon oxynitride.

5. The method as claimed in claim 1, wherein the fluid channel is formed by wet etching.

6. The method as claimed in claim 5, wherein wet etching is performed using KOH, tetramethyl ammonium hydroxide (EDP), or ethylene diamine pyrochatechol (EDP) soluition.

7. The method as claimed in claim 1, wherein the portion of the sacrificial layer is removed by wet etching.

8. The method as claimed in claim 7, wherein wet etching is performed using HF solution.

9. The method as claimed in claim 1, wherein the portion of the sacrificial layer is removed by dry etching.

10. The method as claimed in claim 1, further comprising enlarging the first fluid chamber and the exit-end of the fluid channel.

11. The method as claimed in claim 10, wherein the first fluid chamber and the exit-end of the fluid channel are enlarged using KOH, tetramethyl ammonium hydroxide (EDP), or ethylene diamine pyrochatechol (EDP) soluition.

12. The method as claimed in claim 1, wherein the remaining portion of the sacrificial layer is removed by wet etching.

13. The method as claimed in claim 12, wherein wet etching is achieved using HF solution.

14. The method as claimed in claim 1, wherein the remaining portion of the sacrificial layer is removed by dry etching.

15. The method as claimed in claim 1, further comprising enlarging the second chamber.

16. The method as claimed in claim 1, further comprising repeating steps of removing a portion of the sacrificial layer and enlarging the fluid chamber.

17. The method as claimed in claim 1, further comprising forming a nozzle by etching the structural layer, thereby communicating with the fluid chamber.
